(19) United States
(12) Patent Application Publication
(10) Pub. No.: US 2025/0111476 A1
(43) Pub. Date: Apr. 3, 2025

(54) NEURAL NETWORK ARCHITECTURE FOR IMPLICIT LEARNING OF A PARAMETRIC DISTRIBUTION OF DATA

(71) Applicant: NVIDIA Corporation, Santa Clara, CA (US)

(72) Inventors: Benjamin David Eckart, Oakland, CA (US); Anthea Li, San Jose, CA (US); Chao Liu, Santa Clara, CA (US); Kevin Shih, Cambridge, MA (US); Jan Kautz, Lexington, MA (US)

(21) Appl. No.: 18/890,544

(22) Filed: Sep. 19, 2024

Related U.S. Application Data
(60) Provisional application No. 63/541,718, filed on Sep. 29, 2023.

(51) Int. Cl. G06T 3/4046

(52) U.S. Cl. CPC G06T 3/4046

(57) ABSTRACT

Parametric distributions of data are one type of data model that can be used for various purposes such as for computer vision tasks that may include classification, segmentation, 3D reconstruction, etc. These parametric distributions of data may be computed from a given data set, which may be unstructured and/or which may include low-dimensional data. Current solutions for learning parametric distributions of data involve explicitly learning kernel parameters. However, this explicit learning approach is not only inefficient in that it requires a high computational cost (i.e. from a large number of floating point operations per second), but it also leaves room for improvement in terms of accuracy of the resulting learned model. The present disclosure provides a neural network architecture that implicitly learns a parametric distribution of data, which can reduce the computational cost while improve accuracy when compared with prior solutions that rely on the explicit learning design.

### CLAIM OF PRIORITY

This application claims the benefit of U.S. Provisional Application No. 63/541,718 (Attorney Docket No. NVIDP1385+/23-SC-0800US01) titled “KERNEL DISTANCE TRANSFORM FOR LEARNING EFFICIENT POINT CLOUD REPRESENTATION,” filed Sep. 29, 2023, the entire contents of which is incorporated herein by reference.

### TECHNICAL FIELD

The present disclosure relates to neural networks that learn parametric distributions of data.

### BACKGROUND

Parametric distributions of data are one type of data model that can be used for various purposes. These parametric distributions of data may be computed from a given data set, which may be unstructured and/or which may include low-dimensional data, such as a three-dimensional (3D) point cloud. In some examples, the parametric distributions of data may take the form of a blob, such as a Gaussian blob or a Laplacian blob. Applications for these parametric distributions of data include computer vision tasks, such as classification, segmentation, 3D reconstruction, etc.

Current solutions for learning parametric distributions of data involve explicitly learning kernel parameters. However, this explicit learning approach is not only inefficient in that it requires a high computational cost (i.e. from a large number of floating point operations per second), but it also leaves for improvement in terms of accuracy of the resulting learned model.

There is a need for addressing these issues and/or other issues associated with the prior art. For example, there is a need to provide a neural network architecture that implicitly learns a parametric distribution of data, which can reduce the computational cost while improve accuracy when compared with prior solutions that rely on the explicit learning design.

### SUMMARY

A method, computer readable medium, and system are disclosed to learn a parametric distribution of data. A parametric distribution of data is implicitly learned by at least one neural network. The parametric distribution of the data is output.

### BRIEF DESCRIPTION OF THE DRAWINGS

FIG. 1 illustrates a method to learn a parametric distribution of data, in accordance with an embodiment.

FIG. 2 illustrates a neural network of a multi-neural network architecture configured for implicitly learning a parametric distribution of data, in accordance with an embodiment.

FIG. 3 illustrates a neural network of a single neural network architecture configured for implicitly learning a parametric distribution of data, in accordance with an embodiment.

FIG. 4 illustrates a method of using an implicitly learned parametric distribution of data for a downstream computer vision task, in accordance with an embodiment.

FIG. 5A illustrates inference and/or training logic, according to at least one embodiment;

FIG. 5B illustrates inference and/or training logic, according to at least one embodiment;

FIG. 6 illustrates training and deployment of a neural network, according to at least one embodiment;

FIG. 7 illustrates an example data center system, according to at least one embodiment.

### DETAILED DESCRIPTION

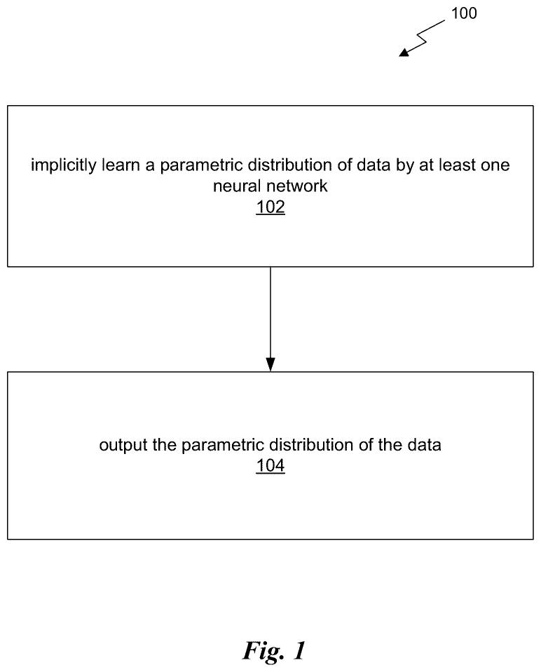

FIG. 1 illustrates a flowchart of a method 100 to learn a parametric distribution of data, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, a parametric distribution of data is implicitly learned by at least one neural network. With respect to the present description, the data may be any type of data from which a parametric distribution may be implicitly learned per the method 100 described herein. In an embodiment, the data may be unstructured. In an embodiment, the data may be unordered. In an embodiment, the data may have non-uniform sparsity. In an embodiment, data may be low-dimensional data. In an embodiment, the data may be a three-dimensional (3D) point cloud, which for example may be comprised of unstructured and low-dimensional data points.

The parametric distribution is a model of the data, and refers to a distribution of the data that is defined in terms of one or more preselected parameters. In an embodiment, the parametric distribution may be defined in terms of shape and range. In an embodiment, the parametric distribution of data may be a blob, such as a Gaussian blob or a Laplacian blob. In an embodiment, the parametric distribution of data may be a set encoding. In an embodiment, the parametric distribution of data may be a positional embedding (e.g. for use as a coordinate-based neural representation). In an embodiment, the parametric distribution of the data may be represented as a learned set of kernel functions (e.g. for use in a neural spline formulation). Thus, while some embodiments may refer to the parametric distribution as being a blob and some embodiments may refer to the parametric distribution as being a kernel function, it should be noted that this different terminology similarly refers to the parametric distribution. As mentioned in greater detail below, the parametric distribution of the data may be of a particular type that is usable by a downstream task.

As mentioned, the parametric distribution of the data is implicitly learned using at least one neural network. Thus, in the present embodiment, the at least one neural network is trained to implicitly learn, for given data, a certain parametric distribution of the data. In an embodiment, the at least one neural network is trained by modifying parameters of the at least one neural network during gradient descent in accordance with a defined loss function that is dependent on the parametric distribution being learned.

In an embodiment, the at least one neural network includes at least one kernel. Implicit learning refers to learning a mapping to a kernel. In an embodiment, the kernel may be an unnormalized (e.g. Gaussian) kernel function. In an embodiment, the kernel may be a normalized probability density function (e.g. multivariate Gaussian distribution), which can provide a network weight regularization in some embodiments.

In an embodiment, the implicit learning may include learning affine transformation parameters. The use of implicit learning is contrary to prior solutions that explicitly learn the kernel parameters. In the present embodiment, for a set of K kernels, each individual kernel may learn to warp the data's original input space differently, thereby producing a set of K different learned distance functions.

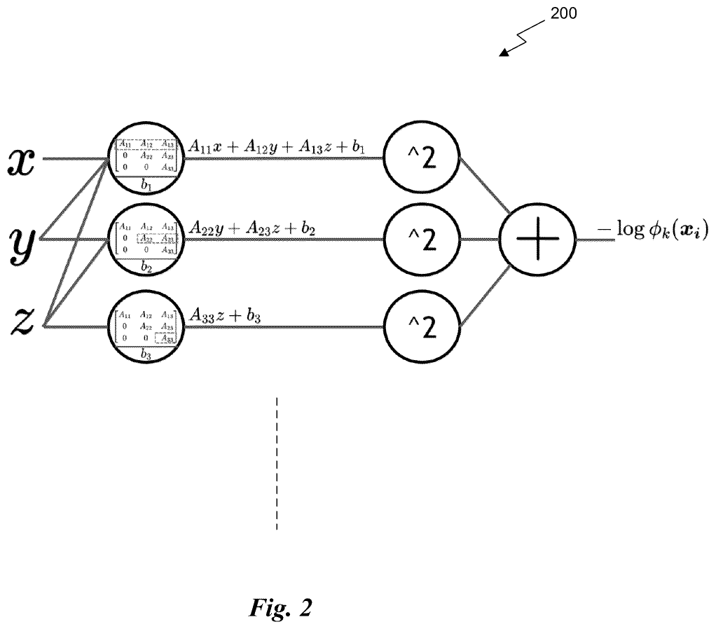

In an embodiment, the implicit learning may be performed using a plurality of neural networks (also referred to herein as a “multi-neural network architecture”). Each of the neural networks may have the same ablated connectivity structure. Each of the neural networks may include a single layer. Each of the neural networks may correspond to a different kernel. Each of the neural networks may have a same number of neurons. The number of neurons may correspond to a dimensionality of an input to the neural network. FIG. 2, as described in more detail below, illustrates an example of one of such neural networks in a multi-neural network architecture configured to implicitly learn the parametric distribution of the data.

With respect to the multi-neural network architecture, each kernel may generate a single output having a plurality of dimensions. In an embodiment, each kernel may include a plurality of neurons, and in a further embodiment each of the plurality of neurons may compute a different dimension of the plurality of dimensions of the single output. Each dimension of the output may be computed based on a given input with the same dimensionality. In an embodiment, an activation function may be applied to the output of each neuron. Output of the activation function for each neuron may then be aggregated, for example via a sum-pool operator or a min-pool operator, where the resulting aggregated output is the single output of the kernel.

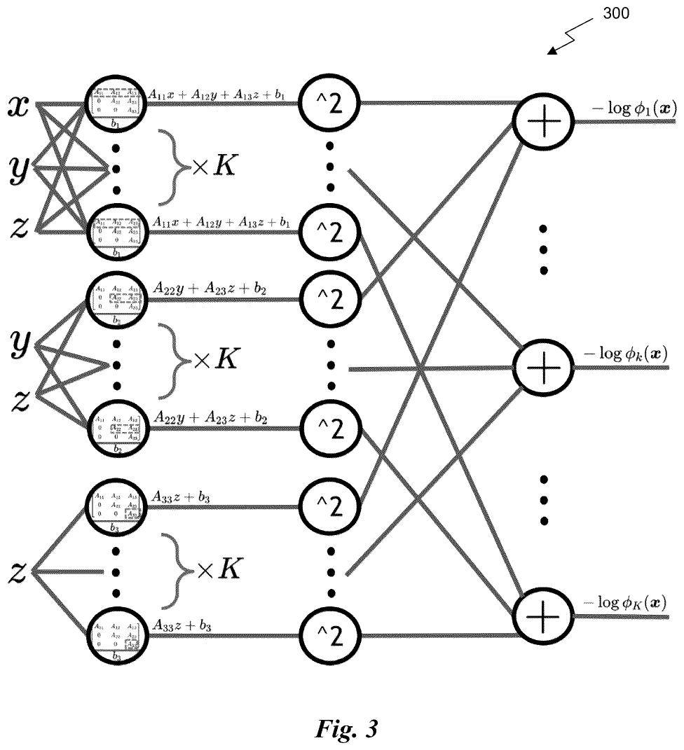

In another embodiment, the implicit learning may be performed using a single neural network (also referred to herein as a “single neural network architecture”). In the present embodiment, the neural network has a plurality of densely connected layers that compute outputs for a plurality of different kernels. The outputs for the plurality of different kernels may be computed in parallel. In an embodiment, each layer of the plurality of densely connected layers includes a plurality of neurons each corresponding to a different kernel of the plurality of different kernels. FIG. 3, as described in more detail below, illustrates an example of the neural network in the single neural network architecture configured to implicitly learn the parametric distribution of the data.

With respect to the single neural network architecture, the neurons of any given layer compute a same dimension of the plurality of different kernels. In this regard, each layer may be configured to compute a different dimension of each of the plurality of different kernels. For example, a first layer may be configured to compute a first dimension of each of the plurality of different kernels, a second layer may be configured to compute a second dimension of each of the plurality of different kernels, and so forth. In an embodiment, an activation function may be applied to the output of each neuron. Output of the activation function for each neuron across the plurality of layers corresponding to a same kernel may then be aggregated, for example via a sum-pool operator or a min-pool operator, to form one of the outputs of the single neural network.

To this end, in an embodiment, the output of the multi-neural network architecture may represent the parametric distribution that has been implicitly learned from the data. In another embodiment, the output of the single neural network architecture may represent the parametric distribution that has been implicitly learned from the data. The parametric distribution may be representative of a point cloud data encoding, a learned positional embedding, a learned set of kernel functions, etc.

In operation 104, the parametric distribution of the data is output. In an embodiment, the parametric distribution of the data may be output to a memory for storage thereof. In an embodiment, the memory may be accessible to a downstream task which is configured to access the parametric distribution of the data. In another embodiment, the parametric distribution of the data may be output directly to a downstream task.

The downstream task refers to a process, function, application, etc. that is configured to use the parametric distribution of the data to generate a resulting output that is associated with the data. In an embodiment, the parametric distribution of data may be a point cloud data encoding, and the point cloud data encoding may be output to a downstream task that includes classification and/or segmentation. In an embodiment, the parametric distribution of data may be a learned positional embedding, and the learned positional embedding may be output for generating a coordinate-based neural representation. In an embodiment, the parametric distribution of data may be a learned set of kernel functions, and the learned set of kernel functions may be output for a 3D reconstruction task.

Further embodiments will now be provided in the description of the subsequent figures. It should be noted that the embodiments disclosed herein with reference to the method 100 of FIG. 1 may apply to and/or be used in combination with any of the embodiments of the remaining figures below.

FIG. 2 illustrates a neural network of a multi-neural network architecture 200 configured for implicitly learning a parametric distribution of data, in accordance with an embodiment. The multi-neural network architecture 200 may be implemented to carry out the method 100 of FIG. 1, in an embodiment. Further, the descriptions and/or definitions given above may equally apply to the present embodiment.

The multi-neural network architecture 200 includes a separate neural network for each of K kernels. The embodiment shown illustrates one of such neural networks for one of such K kernels. The neural network takes a multi-dimensional input and uses a separate neuron to compute a different dimension. An activation function is applied to each neuron's output and the results are aggregated to form the output of the neural network.

In the example shown, the neural network learns affine transformation parameters Aₖ and bₖ for a input xᵢ∈ [symbol] where dimensionality d=3 and xᵢ={x, y, z}. In this example, Aₖ and bₖ comprise the weights and biases, respectively, of the neural network, but with the proper connections ablated in order to ensure Aₖ's triangularity. This forms a single layer neural network with a squaring operation as its activation function. It should be noted that the squaring operation may be used for Gaussian transforms, but other activation functions may be used for other types of transforms. For example, an absolute value operation may be used for a Laplacian transform. Finally, the output of the squared activations are aggregated across each dimension, for example by being sum-pooled or min-pooled across each dimension.

In a further embodiment and in addition to the ablated connections, the output of the neurons corresponding to the diagonal entries of Aₖ may be exponentiated or squared. This is because the exponentiation operation or the square operation will always output positive values which will ensure positive diagonal entries for Aₖ and since positive diagonal entries for Aₖ ensures that the implicit covariance is positive, definite, full rank, non-degenerate, etc.

FIG. 3 illustrates a neural network of a single neural network architecture 300 configured for implicitly learning a parametric distribution of data, in accordance with an embodiment. The single neural network architecture 300 may be implemented to carry out the method 100 of FIG. 1, in an embodiment. In an embodiment, the single neural network architecture 300 may be a more efficient construction than the multi-neural network architecture 200 of FIG. 2. Again, the descriptions and/or definitions given above may equally apply to the present embodiment.

The single neural network architecture 300 includes a neural network with a number of densely connected layers that corresponds to the number of dimensions of the multi-dimensional input to the neural network. Each of the layers computes a same dimension for each of a plurality of kernels. Thus, each of the layers includes a neuron per kernel that computes the kernel dimension corresponding to the layer. The neuron's computation is performed as described above with reference to FIG. 2. This multi-layer arrangement is facilitated by the fact that dimension-wise transformations for each kernel can be computed independently. An activation function is applied to each neuron's output and the results across the layers for each kernel are aggregated to form an output of the neural network.

In the example shown, the neural network includes d densely connected layers where the transformations of a same dimension are grouped together across all K kernels. This organization produces the d dense layers of decreasing input dimensionality, where in the present example d=3. This single neural network architecture 300 described herein allows all K kernel outputs to be efficiently computed in parallel using unmodified dense layers.

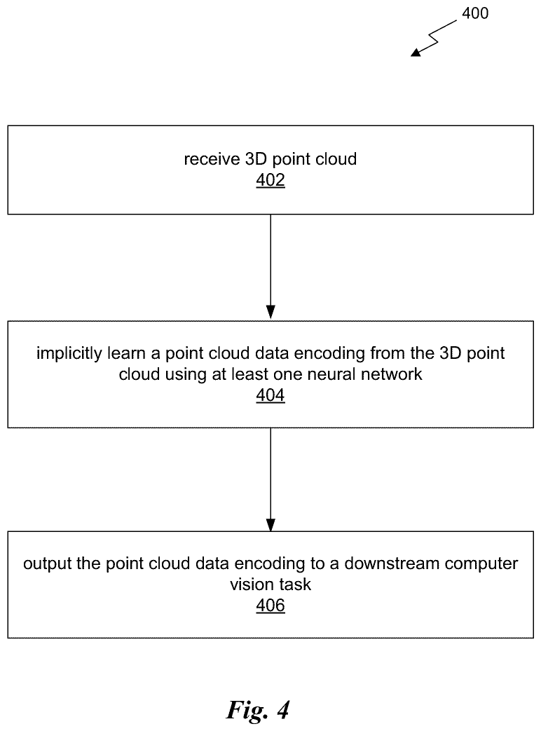

FIG. 4 illustrates a method 400 of using an implicitly learned parametric distribution of data for a downstream computer vision task, in accordance with an embodiment. The method 400 may be carried out in the context of any of the embodiments of the prior Figures. For example, the method 400 may be carried out using the multi-neural network architecture 200 of FIG. 2 or the single neural network architecture 300 of FIG. 3.

In operation 402, a 3D point cloud is received. The 3D point cloud may be an unstructured (e.g. unordered, etc.) set of data points in a 3D coordinate system. The data points may be low-dimensional, sparse (e.g. with random sparsity), etc. The 3D point cloud may model one or more objects in an image, scene, etc.

In operation 404, a point cloud data encoding is implicitly learned from the 3D point cloud using at least one neural network. In an embodiment, the point cloud data encoding may be implicitly learned using the multi-neural network architecture 200 of FIG. 2. In an embodiment, the point cloud data encoding may be implicitly learned using the multi-neural network architecture 300 of FIG. 3. In any case, the at least one neural network has been trained to implicitly learn a point cloud data encoding for a given 3D point cloud.

In an embodiment, the point cloud data encoding may be a representation of the 3D point cloud in a format that is usable by a downstream computer vision task. In an embodiment, the point cloud data encoding may include structured data. In an embodiment, the point cloud data encoding may include high-dimensional data. In an embodiment, the point cloud data encoding may include dense (or less sparse) data.

In operation 406, the point cloud data encoding is output to a downstream computer vision task. In this way, the downstream computer vision task may process the point cloud data encoding to generate an output. In an embodiment, the computer vision task may be a classification task, a segmentation task, etc.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference And Training Logic

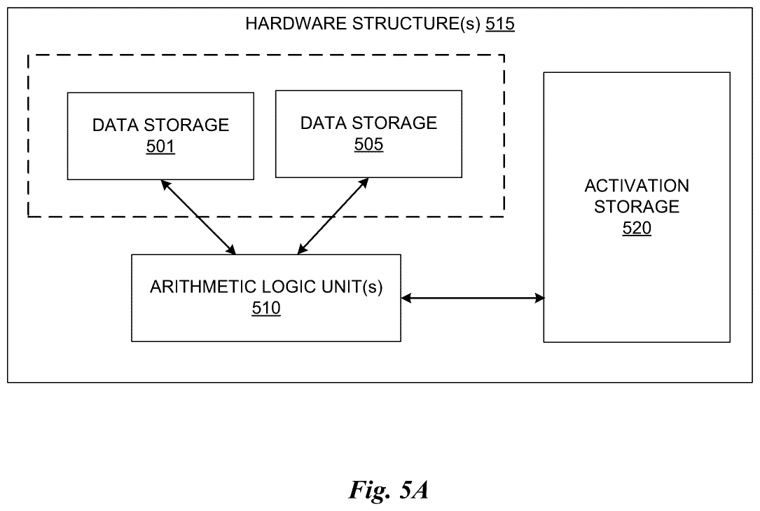

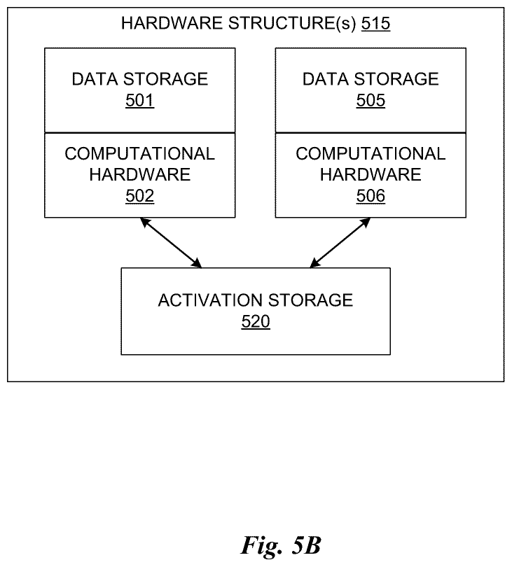

As noted above, a deep learning or neural learning system needs to be trained to generate inferences from input data. Details regarding inference and/or training logic 515 for a deep learning or neural learning system are provided below in conjunction with FIGS. 5A and/or 5B.

In at least one embodiment, inference and/or training logic 515 may include, without limitation, a data storage 501 to store forward and/or output weight and/or input/output data corresponding to neurons or layers of a neural network trained and/or used for inferencing in aspects of one or more embodiments. In at least one embodiment data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 501 may be included with other on-chip or off-chip data storage, including a processor's L1, L2, or L3 cache or system memory.

In at least one embodiment, any portion of data storage 501 may be internal or external to one or more processors or other hardware logic devices or circuits. In at least one embodiment, data storage 501 may be cache memory, dynamic randomly addressable memory (“DRAM”), static randomly addressable memory (“SRAM”), non-volatile memory (e.g., Flash memory), or other storage. In at least one embodiment, choice of whether data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a data storage 505 to store backward and/or output weight and/or input/output data corresponding to neurons or layers of a neural network trained and/or used for inferencing in aspects of one or more embodiments. In at least one embodiment, data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 505 may be included with other on-chip or off-chip data storage, including a processor's L1, L2, or L3 cache or system memory. In at least one embodiment, any portion of data storage 505 may be internal or external to on one or more processors or other hardware logic devices or circuits. In at least one embodiment, data storage 505 may be cache memory, DRAM, SRAM, non-volatile memory (e.g., Flash memory), or other storage. In at least one embodiment, choice of whether data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 501 and data storage 505 may be separate storage structures. In at least one embodiment, data storage 501 and data storage 505 may be same storage structure. In at least one embodiment, data storage 501 and data storage 505 may be partially same storage structure and partially separate storage structures. In at least one embodiment, any portion of data storage 501 and data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510 to perform logical and/or mathematical operations based, at least in part on, or indicated by, training and/or inference code, result of which may result in activations (e.g., output values from layers or neurons within a neural network) stored in an activation storage 520 that are functions of input/output and/or weight parameter data stored in data storage 501 and/or data storage 505. In at least one embodiment, activations stored in activation storage 520 are generated according to linear algebraic and or matrix-based mathematics performed by ALU(s) 510 in response to performing instructions or other code, wherein weight values stored in data storage 505 and/or data 501 are used as operands along with other values, such as bias values, gradient information, momentum values, or other parameters or hyperparameters, any or all of which may be stored in data storage 505 or data storage 501 or another storage on or off-chip. In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 501, data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, data storage 501 and data storage 505, which may be used to store weight values and/or other information, including bias values, gradient information, momentum values, and/or other parameter or hyperparameter information. In at least one embodiment illustrated in FIG. 5B, each of data storage 501 and data storage 505 is associated with a dedicated computational resource, such as computational hardware 502 and computational hardware 506, respectively. In at least one embodiment, each of computational hardware 506 comprises one or more ALUs that perform mathematical functions, such as linear algebraic functions, only on information stored in data storage 501 and data storage 505, respectively, result of which is stored in activation storage 520.

In at least one embodiment, each of data storage 501 and 505 and corresponding computational hardware 502 and 506, respectively, correspond to different layers of a neural network, such that resulting activation from one “storage/computational pair 501/502” of data storage 501 and computational hardware 502 is provided as an input to next “storage/computational pair 505/506” of data storage 505 and computational hardware 506, in order to mirror conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515.

### Neural Network Training and Deployment

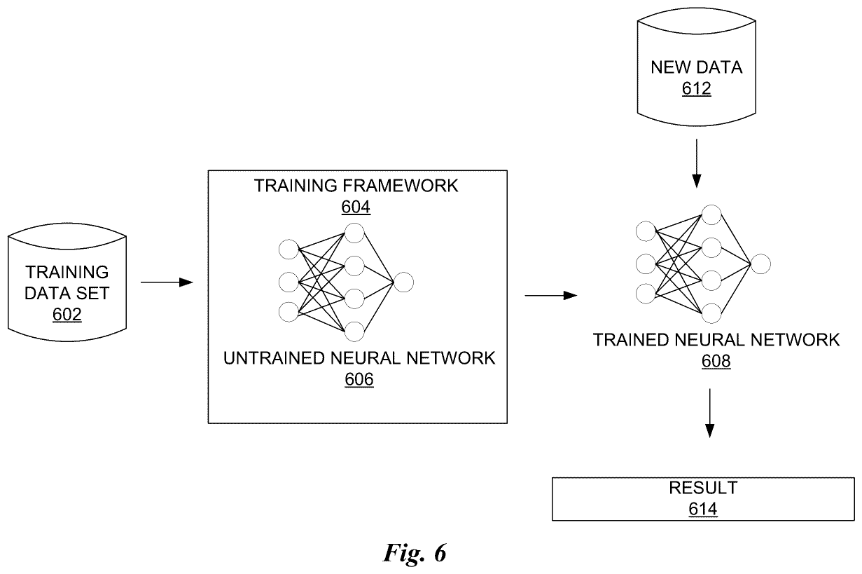

FIG. 6 illustrates another embodiment for training and deployment of a deep neural network. In at least one embodiment, untrained neural network 606 is trained using a training dataset 602. In at least one embodiment, training framework 604 is a PyTorch framework, whereas in other embodiments, training framework 604 is a Tensorflow, Boost, Caffe, Microsoft Cognitive Toolkit/CNTK, MXNet, Chainer, Keras, Deeplearning4j, or other training framework. In at least one embodiment training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having known output and the output of the neural network is manually graded. In at least one embodiment, untrained neural network 606 is trained in a supervised manner processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on known input data, such as new data 612. In at least one embodiment, training framework 604 trains untrained neural network 606 repeatedly while adjust weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map, which is a type of trained neural network 608 capable of performing operations useful in reducing dimensionality of new data 612. In at least one embodiment, unsupervised training can also be used to perform anomaly detection, which allows identification of data points in a new dataset 612 that deviate from normal patterns of new dataset 612.

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new data 612 without forgetting knowledge instilled within network during initial training.

### Data Center

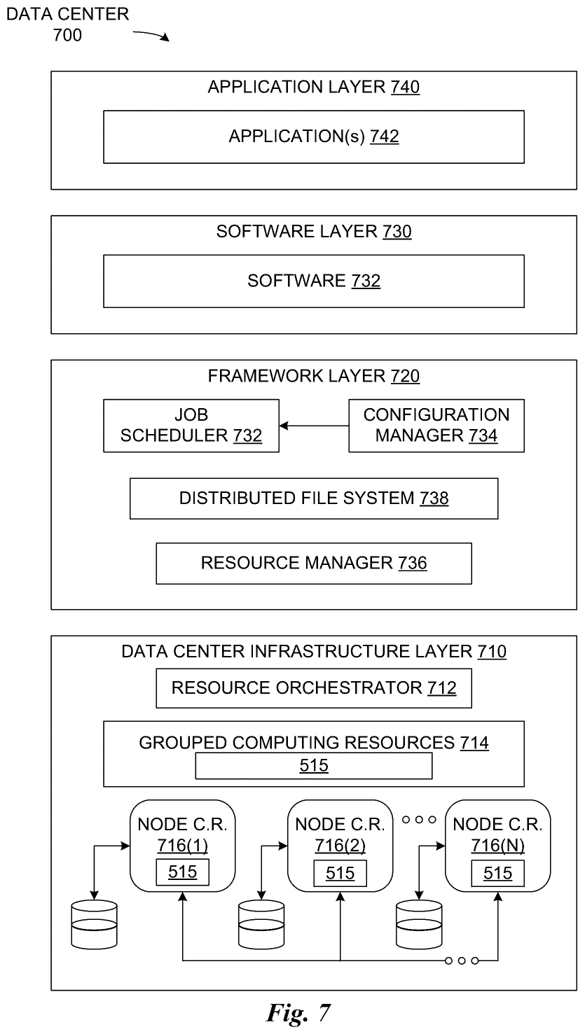

FIG. 7 illustrates an example data center 700, in which at least one embodiment may be used. In at least one embodiment, data center 700 includes a data center infrastructure layer 710, a framework layer 720, a software layer 730 and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716 (1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 722 may configure or otherwise control one or more node C.R.s 716(1)-716(N) and/or grouped computing resources 714. In at least one embodiment, resource orchestrator 722 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 732, a configuration manager 734, a resource manager 736 and a distributed file system 738. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. In at least one embodiment, configuration manager 734 may be capable of configuring different layers such as software layer 730 and framework layer 720 including Spark and distributed file system 738 for supporting large-scale data processing. In at least one embodiment, resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. In at least one embodiment, resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

As described herein, a method, computer readable medium, and system are disclosed to use at least one neural network to implicitly learn a parametric distribution of data. In accordance with FIGS. 1-4, embodiments may provide one or more neural networks usable for performing inferencing operations and for providing inferenced data. The neural networks may be stored (partially or wholly) in one or both of data storage 501 and 505 in inference and/or training logic 515 as depicted in FIGS. 5A and 5B. Training and deployment of the neural networks may be performed as depicted in FIG. 6 and described herein. Distribution of the neural networks may be performed using one or more servers in a data center 700 as depicted in FIG. 7 and described herein.

What is claimed is:

1. A method, comprising:
at a device:
implicitly learning a point cloud data encoding from a three-dimensional (3D) point cloud having unstructured and low-dimensional data, using a single neural network having a plurality of densely connected layers each configured to process a different dimensionality of input, including:
providing to each layer of the plurality of densely connected layers the input of the dimensionality that the layer is configured to process,
at each layer of the plurality of densely connected layers computing from the provided input a dimension-wise transformation for each of a plurality of kernels, wherein the computing across the plurality of densely connected layers is performed in parallel,
applying a non-linear activation to a result of each of the dimension-wise transformations computed across the plurality of densely connected layers to generate a modified dimension-wise transformation result, and
for each kernel of the plurality of kernels, aggregating the modified dimension-wise transformation results computed across the plurality of densely connected layers to generate a single output for the kernel,
wherein the outputs of the plurality of kernels represents the point cloud data encoding;
outputting the point cloud data encoding to a downstream computer vision task.

2. The method of claim 1, wherein the dimension-wise transformation is a Gaussian transform.

3. The method of claim 2, wherein the non-linear activation is a squaring function.

4. The method of claim 1, wherein the dimension-wise transformation is a Laplacian transform.

5. The method of claim 4, wherein the non-linear activation is an absolute value function.

6. The method of claim 1, wherein each dimension-wise transformation is performed at each layer of the plurality of densely connected layers using a different neuron.

7. The method of claim 1, wherein the outputs of the plurality of kernels are generated in one iteration.

8. The method of claim 1, wherein the point cloud data encoding is a blob.

9. The method of claim 1, wherein the computer vision task uses the point cloud data encoding for classification.

10. The method of claim 1, wherein the computer vision task uses the point cloud data encoding for segmentation

11. A method, comprising:
at a device:
implicitly learning a parametric distribution of data by at least one neural network; and
outputting the parametric distribution of the data.

12. The method of claim 11, wherein the data is unstructured.

13. The method of claim 11, wherein the data is unordered.

14. The method of claim 11, wherein the data has non-uniform sparsity.

15. The method of claim 11, wherein the data is low-dimensional data.

16. The method of claim 11, wherein the data is a three-dimensional (3D) point cloud.

17. The method of claim 11, wherein the at least one neural network includes at least one kernel.

18. The method of claim 17, wherein the at least one neural network is a plurality of neural networks each corresponding to a different kernel.

19. The method of claim 18, wherein each neural network of the plurality of neural networks includes a single layer.

20. The method of claim 18, wherein each kernel generates a single output having a plurality of dimensions.

21. The method of claim 20, wherein each kernel includes a plurality of neurons.

22. The method of claim 21, wherein each neuron of the plurality of neurons computes a different dimension of the plurality of dimensions of the single output.

23. The method of claim 22, wherein each neuron of the plurality of neurons computes the different dimension of the single output based on input with a different dimensionality.

24. The method of claim 23, wherein an activation function is applied to output of each neuron of the plurality of neurons per kernel.

25. The method of claim 24, wherein output of the activation function for each neuron of the plurality of neurons is aggregated.

26. The method of claim 25, wherein the output of the activation function for each neuron of the plurality of neurons is aggregated via a sum-pool operator.

27. The method of claim 17, wherein the at least one neural network is a single neural network having a plurality of densely connected layers that compute outputs for a plurality of different kernels.

28. The method of claim 27, wherein the outputs for the plurality of different kernels are computed in parallel.

29. The method of claim 28, wherein each layer of the plurality of densely connected layers includes a plurality of neurons each corresponding to a different kernel of the plurality of different kernels and computing a same dimension of the plurality of different kernels.

30. The method of claim 29, wherein an activation function is applied to output of each neuron of the plurality of neurons per layer.

31. The method of claim 30, wherein output of the activation function for each neuron across the plurality of layers corresponding to a same kernel are aggregated to form one of the outputs of the single neural network.

32. The method of claim 11, wherein the parametric distribution of the data is a blob.

33. The method of claim 32, wherein the parametric distribution of the data is a Gaussian blob.

34. The method of claim 32, wherein the parametric distribution of the data is a Laplacian blob.

35. The method of claim 11, wherein the parametric distribution of the data is output to a downstream task.

36. The method of claim 11, wherein the parametric distribution of the data is a point cloud data encoding, and wherein the point cloud data encoding is output to a downstream task that includes at least one of classification or segmentation.

37. The method of claim 11, wherein the parametric distribution of the data is a learned positional embedding, and wherein the learned positional embedding is output for generating a coordinate-based neural representation.

38. The method of claim 11, wherein the parametric distribution of the data is a learned set of kernel functions, and wherein the learned set of kernel functions is output for a three-dimensional (3D) reconstruction task.

39. A system, comprising:
a non-transitory memory storage comprising instructions; and
one or more processors in communication with the memory, wherein the one or more processors execute the instructions to:
implicitly learn a parametric distribution of data by at least one neural network; and
output the parametric distribution of the data.

40. The system of claim 39, wherein the at least one neural network is a plurality of neural networks each corresponding to a different kernel, and wherein each neural network of the plurality of neural networks includes a single layer, and wherein each kernel generates a single output having a plurality of dimensions.

41. The system of claim 39, wherein the at least one neural network is a single neural network having a plurality of densely connected layers that compute outputs for a plurality of different kernels, wherein the outputs for the plurality of different kernels are computed in parallel.

42. The system of claim 39, wherein the parametric distribution of the data is a blob.

43. A non-transitory computer-readable media storing computer instructions which when executed by one or more processors of a device cause the device to:
implicitly learn a parametric distribution of the data by at least one neural network; and
output the parametric distribution of the data.

44. The non-transitory computer-readable media of claim 43, wherein the at least one neural network is a plurality of neural networks each corresponding to a different kernel, and wherein each neural network of the plurality of neural networks includes a single layer, and wherein each kernel generates a single output having a plurality of dimensions.

45. The non-transitory computer-readable media of claim 43, wherein the at least one neural network is a single neural network having a plurality of densely connected layers that compute outputs for a plurality of different kernels, wherein the outputs for the plurality of different kernels are computed in parallel.

46. The non-transitory computer-readable media of claim 43, wherein the parametric distribution of the data is a blob.
